(19) United States
(12) Patent Application Publication
(10) Pub. No.: US 2022/0268263 A1
(43) Pub. Date: Aug. 25, 2022

(54) Gas-filling device

(71) Applicant: Shengwei Liang, Weihai (CN)

(72) Inventor: Shengwei Liang, Weihai (CN)

(21) Appl. No.: 17/182,252

(22) Filed: Feb. 23, 2021

(51) Int. Cl. F04B 33/00; B60S 5/04; F04B 39/10; F04B 39/00

(52) U.S. Cl. CPC F04B 33/00; B60S 5/04; F04B 39/10; F04B 39/0005

(57) ABSTRACT

The utility model relates to a new type of Gas-filling device, which includes a support tube with hollow tubular structure. The upper side wall of the said support tube is provided with air inlet, and the support tube is provided with an integrated pressure measuring piston sliding along the central axis of the support tube. The integrated pressure measuring piston includes one-way valve piston body, hollow cylinder, buffer chamber, barometer and anti-skid handle that are sealed connection in sequence from bottom to top, and the side wall of the said buffer chamber is provided with air outlet, the side wall of the support tube is provided with air outlet hose which is matched and sealed in threaded connection with the air outlet, and honeycomb base is provided under the support tube, and an end cover is sealed and provided on the honeycomb base. The invention belongs to the technical field of Gas-filling devices, and specifically provides a new type of Gas-filling device appropriate for production and life with high practicability, simple operation, accurate air pressure measurement, good stability, durability, high safety factor, convenient dis-assembly and assembly, convenient carrying and storage, and low cost.

### TECHNICAL FIELD

The invention belongs to the technical field of Gas-filling devices, and specifically refers to a new type of Gas-filling device.

### BACKGROUND ART

The Gas-filling device is a product that people often use in production or daily life. The traditional Gas-filling device is a structure with one air chamber and one air nozzle, and there is an internal or external plug in the air nozzle to seal the chamber air. However, the traditional Gas-filling device has the following shortcomings during use: 1. Gas-filling devices such as the barometers of ordinary pumps on the market are easy to break and the air pressure measurement is inaccurate; 2. The handle of the Gas-filling device is difficult to inflate the device to be gas-filled during use, and the handle of the Gas-filling device has a poor touch and laborious use, easy to slip, it is difficult for users to effectively inflate; 3. The pedal position of common Gas-filling devices on the market is easy to break; 4. On account of the air pressure in the air chamber is higher than that outside the air chamber, and the device is squeezed in use, the pressure in the air chamber increases, making the air in the air chamber easily escape from the end cover or the end cover is deformed to produce air leakage, which affects the use; 5. Traditional Gas-filling devices are inconvenient to carry and store; 6. The base is unstable during air inflation, and the overall strength of the Gas-filling device's air chamber is poor. In case of the air chamber leaks due to scratches, abrasion, or dazzling, the device will quickly lose its original form, thereby losing its original use function, and even dangerous; 7. At the interface of the air tube, the connection operation is not convenient.

Therefore, in the market, there is an urgent requirement for a new type of Gas-filling device with various above-mentioned comprehensive and outstanding performances.

### SUMMARY OF THE INVENTION

In order to solve the above-mentioned existing problems, the present invention provides a new type of Gas-filling device suitable for production and life with high practicality, simple operation, accurate air pressure measurement, good stability, durability, high safety factor, convenient dis-assembly and assembly, easy to carry and store, and low cost.

The technical solutions applied by the present invention are as follows: The new type Gas-filling device of the present invention includes a support tube with a hollow tubular structure, the upper side wall of the said support tube is provided with air inlet, and the support tube is provided with an integrated pressure measuring piston sliding along the central axis of the support tube. The integrated pressure measuring piston includes one-way valve piston body, hollow cylinder, buffer chamber, barometer and anti-skid handle that are sealed connection in sequence from bottom to top, and the side wall of the said buffer chamber is provided with air outlet, the side wall of the support tube is provided with air outlet hose which is matched and sealed in threaded connection with the air outlet, and honeycomb base is provided under the support tube, and an end cover is sealed and provided on the honeycomb base. Among them, the inductive air pressure deformation element part of the barometer is connected to the buffer chamber, and the display panel of the barometer is displayed outside and is recessed, which is convenient for the user to view the air pressure value and has a high safety factor. A new type of barometer setting is applied on the new type Gas-filling device of the present invention, which solves the problems that the barometer of ordinary pumps in the market is easy to break and the air pressure measurement is not accurate.

Further, an intake filter screen is provided on the air inlet hole. The air intake filter effectively filters out impurities in the air, effectively avoiding impurities entering the internal structure of the Gas-filling device from friction and damage.

Further, the one-way valve piston body includes piston body, the piston body is provided with piston body air inlet hole, and the piston body air inlet is setting with a movable plug. The setting of the one-way valve piston body can ensure that when the anti-skid handle is raised, the air flow enters the chamber of the support tube. When the anti-skid handle is pressed down, the piston air inlet valve blocks the air inlet of the piston body and opens the piston air outlet valve to allow air flow to enter the hollow cylinder, then enter the buffer chamber, and the airflow enters the device to be inflated through the air outlet and the air outlet hose respectively.

Preferably, the movable plug incorporates the piston intake valve, and the cross-sectional area of the piston intake valve is larger than that of the air inlet of the piston body.

Of which, the piston intake valve is arranged at the bottom of the air inlet of the piston body, the sealing ring of the piston rubber is in slip connection with the air inlet of the piston body, and the cross-sectional area of the fixed pillar is larger than that of the air inlet of the piston body. When the anti-skid handle is raised, after the airflow entering from the air inlet of the piston body pushes the piston air inlet valve open through the air inlet of the piston body, and the fixed pillar can effectively fix the movable plug as a whole without falling.

Further, the one-way valve piston body is provided with a sealed in threaded connection that is matched and connected with the hollow cylinder, which is convenient for the sealing connection between the hollow cylinder and the one-way valve piston body. Preferably, a sealing ring is provided on the outer periphery of the one-way valve piston to effectively ensure sealing.

Preferably, the honeycomb base is a base provided with a honeycomb-shaped groove at the bottom, and the cross-section of the honeycomb base is arranged in a B-shaped with a convex arc on the side wall. The honeycomb-shaped groove and the B-shaped base can ensure that the new type of Gas-filling device of the present invention is more stable when used. The honeycomb-shaped grooves increase the strength of the product and enhance the stability of the product. In addition, the back structure of the pedal position of the Gas-filling device is redesigned to a B-shaped structure with a convex side wall (or a longitudinal cross-section structure of a peanut-like fruit), which avoids the problem of easy breakage of products on the market. A sealing ring is arranged between the honeycomb base and the end cover, and the sealing ring ensures that the inside of the new type of Gas-filling device of the present invention is effectively sealed and air-tight. The new type of Gas-filling device of the present invention is provided with an end cover structure, and the end cover structure and the position of the end cover are redesigned to avoid the air leakage problem caused by the frequent deformation of the products on the market. Preferably, the end cover is provided with a honeycomb-shaped groove.

Further, the side wall of the support tube is provided with a fixing groove, and an elastic rope is provided on the fixing groove. Preferably, the fixing groove is a C-shaped groove. The arrangement of the fixing groove and the elastic rope can stabilize the air outlet hose on the side wall of the support tube. Comparing with ordinary products on the market, the new type of Gas-filling device the present invention is easier to store and carry after use.

Further, one end of the air outlet hose is provided with a female head of inflation tube connected to the air outlet, and the other end of the air outlet hose is provided with a male head that is sealed to the gas filled nozzle of the device to be inflated. Preferably, a thumb wrench 27 for easy operation and rotation is provided on the above-mentioned joint. The thumb wrench 27 is provided with a groove that matches the touch by the custom's finger. The groove shape of the groove matches the human finger. The setting of the groove can assist the balance force when the thumb wrench 27 is rotated.

Preferably, there is a fast-rotating snap-on connection joint for connecting the Gas-filling products. Further, the above-mentioned anti-skid handle is a hollow bending setting that is gradually expanded in arc-shaped from inside to outside along the intersection direction of the central axis of the support tube and the vertical line along the central axis of the support tube. The surface of the anti-skid handle is provided with skid-proof stripe, and the free end of the anti-skid handle is setting upturning. The above-mentioned anti-skid handle has been redesigned, comparing with ordinary products on the market, the anti-skid handle has a better stress-bearing point and an anti-skid design, which increases the tactile feel in the process of the handle operating, makes the operation process more labor-saving, and has a better anti-skid effect.

The beneficial effects of the present invention obtained by using the above structure are as follows: the new type of Gas-filling device in this scheme has a reasonable structure design, and is suitable for inflating various Gas-filling products such as inflatable paddle boards, inflatable boats, assault boats, drifting boats, etc, which has universality, compact design, and the firm structure. It has the comprehensive advantages of high practicability, accurate air pressure measurement, good stability, durability, high safety factor, convenient dis-assembly and assembly, easy carrying and storage, low cost, simple operation, etc., which can effectively improve the efficiency and service life of the Gas-filling device, reduce the risk factor, greatly improve the user's sense of stability, security and touch.

### FIGURE LEGENDS

FIG. 1 is a schematic diagram of the overall structure of the front of the new Gas-filling device of the present invention;

FIG. 2 is a schematic diagram of the overall structure of the reverse side of the new Gas-filling device of the present invention;

FIG. 3 is a schematic diagram of the overall structure of the new type of Gas-filling device of the present invention after the bottom is turned over;

FIG. 4 is a schematic diagram of the overall internal structure of the new type of Gas-filling device of the present invention with the support tube and honeycomb base concealed;

FIG. 5 is a longitudinal sectional view of the front view structure of the new type of Gas-filling device of the present invention;

FIG. 6 is a front three-dimensional structural view of the piston body of the one-way valve piston body of the new type of Gas-filling device of the present invention;

FIG. 7 is a three-dimensional structural view of the reverse side of the piston body of the one-way valve piston body of the new type of Gas-filling device of the present invention; Among them, 1. Support tube, 2. Air inlet, 3. Integrated pressure measuring piston, 4. One-way valve piston body, 5. Hollow cylinder, 6. Buffer chamber, 7. Barometer, 8. Anti-skid handle, 9. Air outlet, 10, Inflation hose, 11. Honeycomb base, 12. End cover, 13. Air inlet filter, 14. Piston air inlet, 15. Piston air inlet valve, 16. Piston air outlet, 17. Piston air outlet valve, 18. Piston sealing ring, 19. Hollow cylinder connecting thread, 20. End cap sealing ring, 21. Elastic rope fixing groove, 22. Elastic rope, 23. Male head of inflation tube , 24. Inflatable tube male head seal ring, 25. Female head of inflation tube, 26. Piston body, 27. Thumb wrench.

### MODE OF CARRYING OUT THE INVENTION

The technical solutions of this present invention will be described in further detail below in conjunction with specific implementations. The technical features or connection relationships of the present invention that are not described in detail are all the existing technologies applied. The present invention will be further described in detail below with reference to the accompanying drawings.

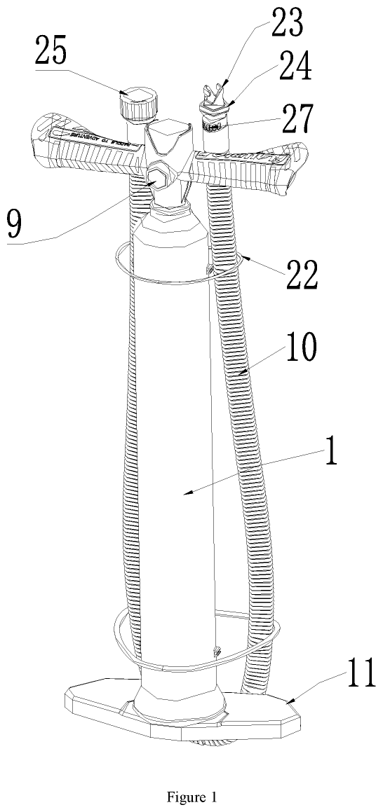

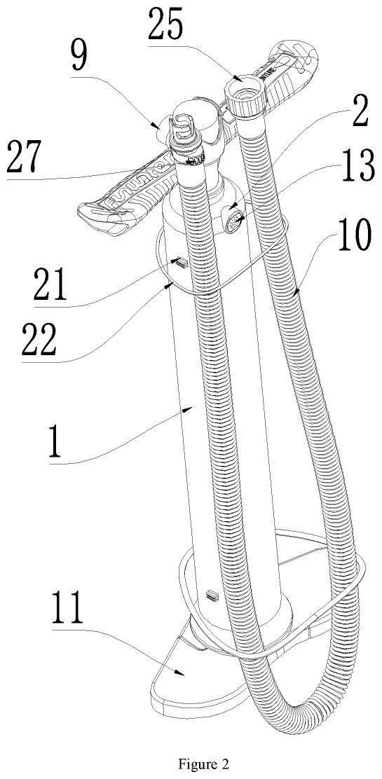

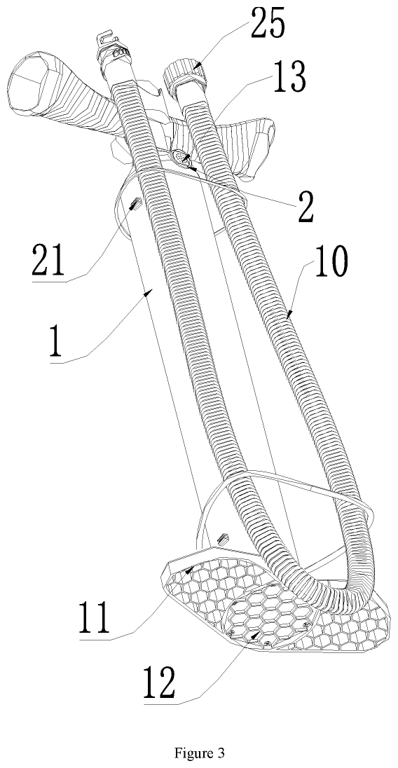

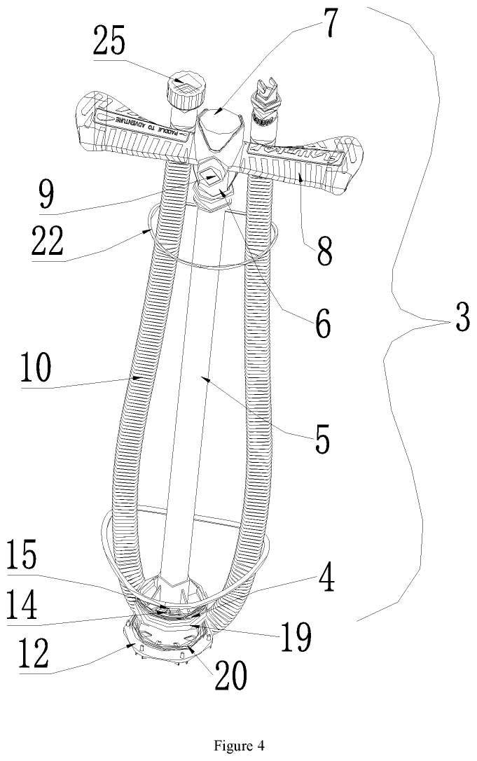

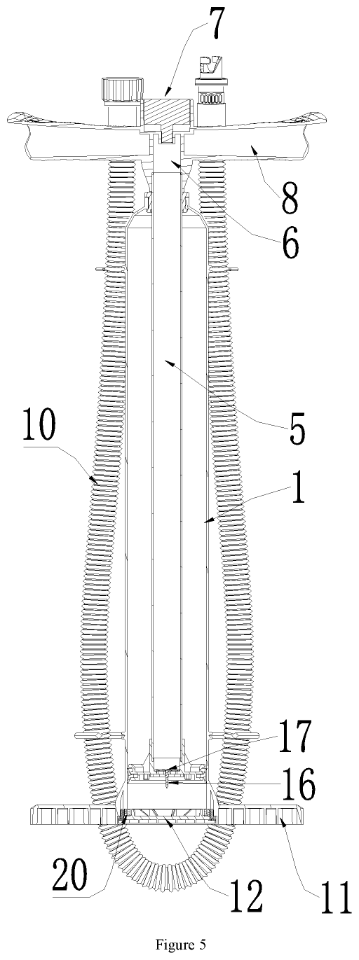

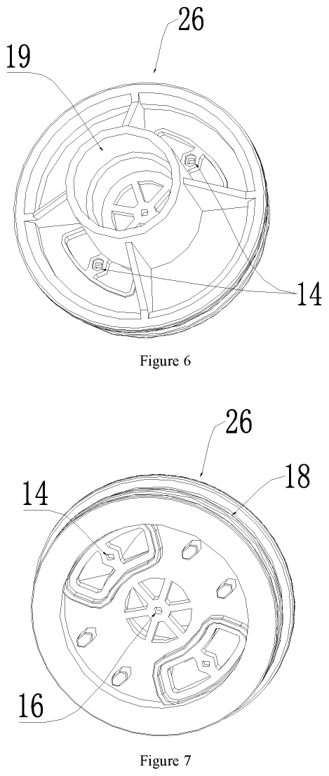

As shown in FIGS. 1-8, the new type of Gas-filling device of the present invention includes a support tube 1 with hollow tubular structure. The upper side wall of the said support tube 1 is provided with air inlet 2, and the support tube 1 is provided with an integrated pressure measuring piston 3 sliding along the central axis of the support tube 1. The integrated pressure measuring piston 3 includes one-way valve piston body 4, hollow cylinder 5, buffer chamber 6, barometer 7 and anti-skid handle 8 that are sealed connection in sequence from bottom to top, and the side wall of the said buffer chamber 6 is provided with air outlet 9, the side wall of the support tube 1 is provided with air outlet hose 10 which is matched and sealed in threaded connection with the air outlet 9, and honeycomb base 11 is provided under the support tube 1, and an end cover 12 is sealed and provided on the honeycomb base 11. Wherein, the air inlet 2 is provided with air inlet filter 13. The one-way valve piston body 4 includes piston body 26, and the piston body 26 is integrally formed. The piston body is provided with a piston body inlet 14 and the piston body inlet 14 is provided with piston inlet valve 15. The piston inlet valve 15 includes piston outlet valve 17 and piston seal ring 18. The cross-sectional area of the piston outlet valve 17 is larger than that of the piston inlet hole 14, and the cross-sectional area of the fixed pillar is larger than that of the piston inlet hole 14. The one-way valve piston body 4 is provided with a hollow cylinder connecting thread 19 matched and connected with the hollow cylinder 5. The honeycomb base 11 is a honeycomb-shaped groove base at the bottom. The cross-section of the honeycomb base 11 is arranged in a B-shaped with a convex arc on the side wall. A sealing ring 20 is provided between the honeycomb base 11 and the end cover 12. The side wall of the support tube 1 is provided with an elastic rope fixing groove 21, and elastic rope 22 is provided on the elastic rope fixing groove 21. One end of the air outlet hose 10 is provided with a female head 25 of inflation tube connected to the air outlet 9, and the other end of the air outlet hose 10 is provided with a male head 23 that is sealed to the gas filled nozzle of the device to be inflated.

Preferably, the male head of inflation tube 23 is provided with a thumb wrench 27 for easy operation and rotation and inflatable tube male head seal ring 24. The above-mentioned anti-skid handle 8 is a hollow bending setting that is gradually expanded in arc-shaped from inside to outside along the intersection direction of the central axis of the support tube 1 and the vertical line along the central axis of the support tube. The surface of the anti-skid handle 8 is provided with skid-proof stripe, and the free end of the anti-skid handle 8 is setting upturning.

Preferably, the male head of inflation tube 23 is an inflation product connector with a thumb wrench 27. In specific operation, the user takes out the new type of Gas-filling device of the present invention, and tightens and seals the inflation hose 10 to the air outlet 9 through the female head of inflation tube 25, and the male head of inflation tube 23 is screwed and connected to the air nozzle of the device to be inflated, at this time, the gas-filling preparation is now ready. However, if the user requires to inflate an inflatable product such as an inflatable paddle board, connect the male head of inflation tube 23 to the inlet valve of the product to be inflated. And then the user starts to inflate, first the user steps on the honeycomb base 11, holds and lifts the anti-skid handle 8 upwards. At this time, the air flow is filtered by the air inlet filter 13 and enters the inflation room between the support tube 1 and the hollow cylinder 5 through the air inlet 2 , with the influx of airflow, the airflow pushes the piston air inlet valve 15 on the piston body 26 downwards. At this time, the piston air inlet 14 opens and the airflow flows from the piston air inlet 14 into the inflation room between the lower part of the piston body 26 and the support tube 1; then the user lifts the anti-skid handle 8 to a proper distance, press the anti-skid handle 8 downward, and under the resistance of lower end air pressure the piston air inlet valve 15 quickly shifts upwards and seals and blocks the piston air inlet 14; the user continues to push the anti-skid handle 8 downwards, because of the central section of piston body 26 is provided with piston air outlet 16, at this time, under the lower end air pressure the piston air outlet 16 quickly shifts upwards and opens the piston air outlet valve 17, so the air flow passes through the central through hole of the piston body 26, the inner chamber of the hollow cylinder 5, and the buffer chamber 6, and then passes through the air outlet 9 and the inflation hose 10. Finally, the airflow is filled into the device to be filled. The setting of the one-way valve piston body 4 can ensure that when the anti-skid handle 8 is lifted upward, the airflow enters the chamber of the support tube 1, and when the anti-skid handle 8 is pressed down, the airflow enters the hollow cylinder 5, and then the airflow enters the buffer chamber 6. Finally, the airflow enters into the device to be inflated through the air outlet 9 and the inflation hose 10 respectively. The above-mentioned anti-skid handle has been redesigned, comparing with ordinary products on the market, the anti-skid handle has a better stress-bearing point and an anti-skid design, which increases the tactile feel in the process of the handle operating, makes the operation process more labor-saving, and has a better anti-skid effect.

The present invention and its Mode of Carrying out the Invention have been described above, and this description is not restrictive. What is shown in the drawings is only one of the Mode of Carrying out the Invention of the present invention, and the actual structure is not limited thereto. To sum up, if ordinary technicians in the field are inspired by the invention and design a structural mode and Mode of Carrying out the Invention similar to the technical scheme without creativity without deviating from the purpose of creation of the invention, they shall fall within the scope of protection of the present invention.

1. A new type of Gas-filling device, comprising a support tube with a hollow tubular structure, characterized as follows: the upper side wall of the mentioned support tube is provided with air inlet, and the support tube is provided with an integrated pressure measuring piston sliding along the central axis of the support tube. The integrated pressure measuring piston includes one-way valve piston body, hollow cylinder, buffer chamber, barometer and anti-skid handle that are sealed connection in sequence from bottom to top, and the side wall of the mentioned buffer chamber is provided with air outlet, the side wall of the support tube is provided with air outlet hose which is matched and sealed in threaded connection with the air outlet, and honeycomb base is provided under the support tube, and an end cover is sealed and provided on the honeycomb base.

2. The utility model relates to a new type of Gas-filling device according to claim 1, characterized in that: the mentioned air inlet hole is provided with an air inlet filter.

3. The utility model relates to a new type of Gas-filling device according to claim 1, characterized in that: the one-way valve piston body includes a piston body, the piston body is provided with a piston body air inlet, and air inlet of the piston body is provided with a movable plug.

4. The utility model relates to a new type of Gas-filling device according to claim 3, characterized in that: the mentioned movable plug includes intake movable plug, slow connection pillar and fixed pillar, and the cross-sectional area of the intake movable plug is larger than that of the air inlet of the piston body, and the cross-sectional area of the mentioned fixed pillar is larger than that of the the air inlet of the piston body.

5. The utility model relates to a new type of Gas-filling device according to claim 1, characterized in that: the one-way valve piston body is provided with a sealed in threaded connection with the hollow cylinder.

6. The utility model relates to a new type of Gas-filling device according to claim 1, characterized in that: the mentioned honeycomb base is a base with a honeycomb-shaped groove at the bottom, and the mentioned cross-section of the honeycomb base is setting B-shaped with convex side wall , and a sealing ring is arranged between the honeycomb base and the end cover.

7. The utility model relates to a new type of Gas-filling device according to claim 1, characterized in that: wherein the side wall of the support tube is provided with fixing groove, and an elastic cord is provided on the fixing groove.

8. The utility model relates to a new type of Gas-filling device according to claim 1, characterized in that: one end of the air outlet hose is provided with female head of inflatable tube connected to the air outlet, and the other end of the air outlet hose is provided with a joint that is sealedly connected with the air filling nozzle of the device to be gas-filled.

9. The utility model relates to a new type of Gas-filling device according to claim 1, characterized in that: wherein the anti-skid handle is a hollow bending setting that is gradually expanded in arc-shaped from inside to outside along the intersection direction of the central axis of the support tube and the vertical line along the central axis of the support tube. The surface of the anti-skid handle is provided with skid-proof stripe, and the free end of the anti-skid handle is setting upturning.
